(19) United States
(12) Patent Application Publication
(10) Pub. No.: US 2020/0233236 A1
(43) Pub. Date: Jul. 23, 2020

(54) LENS WITH DISCRETE WAVELENGTH FILTERING ZONES

(71) Applicant: BIOHACKED, INC., Kent, WA (US)

(72) Inventors: David Asprey, Cobble Hill (CA); Timothy K. Brodesser, Auburn, WA (US); Karhl Walter Wayman, Kent, WA (US)

(21) Appl. No.: 16/745,870

(22) Filed: Jan. 17, 2020

Related U.S. Application Data
(60) Provisional application No. 62/794,390, filed on Jan. 18, 2019.

(51) Int. Cl. G02C 7/10; G02C 7/06

(52) U.S. Cl. CPC G02C 7/107; G02C 7/063; G02C 7/104

(57) ABSTRACT

An optical lens having three discrete filtering zones is disclosed for eyeglasses. The eyeglasses can be worn two to four hours prior to bedtime to reestablish a proper circadian rhythm even in the presence of artificial evening light. The three discrete filtering zones can differently filter green or blue light.

### INCORPORATION BY REFERENCE TO ANY PRIORITY APPLICATIONS

Any and all applications for which a domestic priority claim is identified in the Application Data Sheet as filed with the present application are hereby incorporated by reference under 37 CFR 1.57.

### BACKGROUND

### Field

The present application relates to a circadian rhythm enhancing lens and a method for making the same.

### Description of the Related Art

Circadian rhythms in humans and other mammals approximate a 24 hour metabolic cycle controlling healthy sleep patterns, body temperature, brain wave activity, hormone production, and cell regulation. Maintenance of a proper circadian rhythm can be desirable for general health, and disruption of circadian rhythms can lead to obesity, poor glucose metabolism, improper plasma cortisol levels, fatigue, and mental health issues. Circadian rhythms can be disrupted by environmental factors, such as shift work, pregnancy, time zone changes, medications, changes in sleep pattern routines, medical problems, or menopause. Various types of circadian rhythm disorders include jet lag, shift and sleep disorders, delayed sleep phase syndrome, advanced phase sleep syndrome and numerous other disorders.

As a result, various treatments have been created to attempt to counteract such circadian rhythm disruptors, including: external stimulus therapy (also known as bright light therapy), chronotherapy (systematically shifting bedtimes to reestablish the proper circadian rhythm), and a variety of blackout masks and curtains to prevent external light stimulus from disrupting the normal circadian rhythm. While such therapies may be effective to reestablish a proper circadian rhythm, such therapies are often inconvenient, expensive, or not well tolerated by a patient.

### SUMMARY

It is therefore an object of the present application to provide a circadian rhythm enhancing optical lens and a method for making the same where the lens blocks significant portions of the physical light spectrum perceived as “daytime” lighting while permitting an individual wearing such lens to continue with normal evening-time activities.

The application can, in certain implementations, achieve the above object, and other objects and advantages which will become apparent from the description which follows, by providing a circadian rhythm enhancing optical lens having upper, middle, and lower portions corresponding to various ocular ranges. The upper, middle, and lower portions can differently filter various wavelengths of visible light. For example, the first ocular range can be approximately 112.5°, while the second and third ocular ranges can be each approximately 33.75°. The first ocular range can filter approximately 98% of blue light wavelengths and 95% of green light wavelengths. The middle ocular range can filter approximately 96% of blue light and approximately 89% of green light. The lower third ocular range can filter approximately 93% of blue light and approximately 76% of green light.

A method for making said lenses is also disclosed in which lens blanks can be vertically positioned in a lens blank holder. The blanks can be ultrasonically cleaned and then dipped into a first tinting solution in a first thermal dye tank. The lens blanks can be then reversed in the lens blank holder and dipped into a second tinting solution in a second thermal dye tank. The blanks can be sufficiently dipped such that an intermediate overlapping portion contains dye from both first and second tanks, thus resulting in a lens blank having an upper portion with a first tint, a lower portion with a second tint, and a middle portion containing a blend of the first and second tints. The first tint can cover approximately 62.5% of the lens blanks' upper surface area, the first and second tints can cover a middle 18.75% of the lens blanks' surface area, and the second tint can cover approximately 18.75% of the lens blanks' lower surface area. The lens blanks can be then curved in a heating process and cut to fit eyeglass frames.

### BRIEF DESCRIPTION OF THE DRAWINGS

FIG. 1 illustrates a lens blank having an upper portion with a first tint, a lower portion with a second tint, and a middle portion with a blend of the first and second tints.

FIG. 2 illustrates a front view of an optical lens that has tints in accordance with the lens blank of FIG. 1.

FIG. 3 illustrates a side view of the optical lens of FIG. 2 and depicts the ocular range of the angle of view of different tinted portions.

FIG. 4 illustrates a lens blank holder and multiple lens blanks prior to tinting of the multiple lens blanks.

FIG. 5 illustrates a perspective view of an ultrasonic lens cleaning tank.

FIG. 6 illustrates a side view of a dipping tank for the multiple lens blanks of FIG. 4.

FIG. 7 illustrates a front perspective view of a second dipping tank for the multiple lens blanks of FIG. 4.

FIG. 8 illustrates a front perspective view of the multiple lens blanks of FIG. 4 after being dipped in two tinting solutions.

FIG. 9 illustrates one of the multiple lens blanks of FIG. 4 before and after bending.

FIG. 10 illustrates the optical lens of FIG. 2 supported by a lens frame.

### DETAILED DESCRIPTION

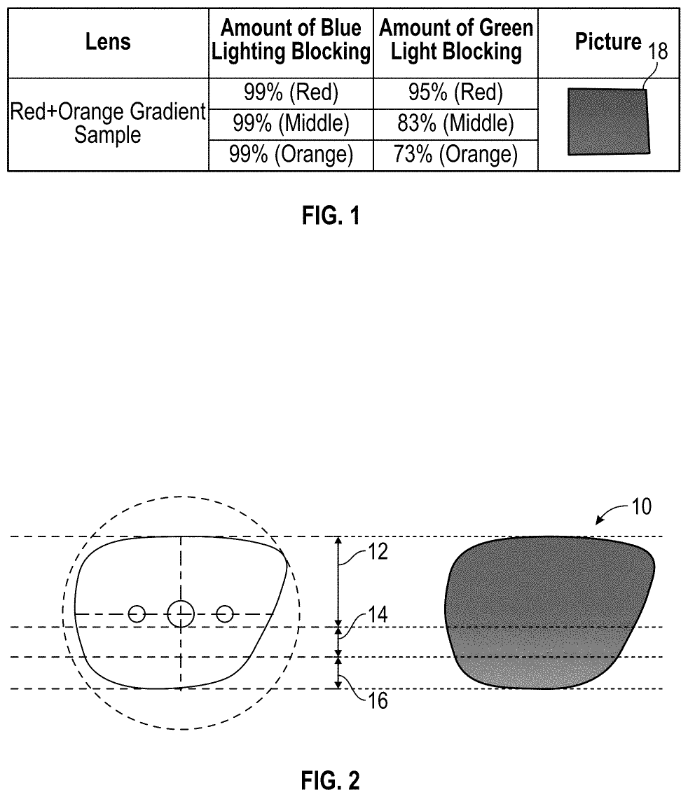

FIG. 2 illustrates an optical lens 10. The optical lens 10 has an upper portion 12, a middle portion 14, and a lower portion 16 that can be tinted to block various wavelengths of the visible spectrum of light to promote reestablishment of a circadian rhythm by wearing glasses incorporating the optical lens 10 for a few hours prior to bedtime. As can be seen in FIG. 1, the optical lens 10 can be manufactured from a lens blank 18 (which can, for example, be 71 mm×60 mm) in which the upper portion 12 can block approximately 99% or 98% of blue light and approximately 95% of green light with a red tint. The lower portion 16 of the lens blank 18 can block approximately 99% or 93% of blue light and approximately 76% or 73% of green light by utilizing an orange tint. The middle portion 14 of the lens blank 18 can block approximately 99% or 96% of blue light and approximately 93%, 89%, or 83% of green light, utilizing a blend of the orange and red tints.

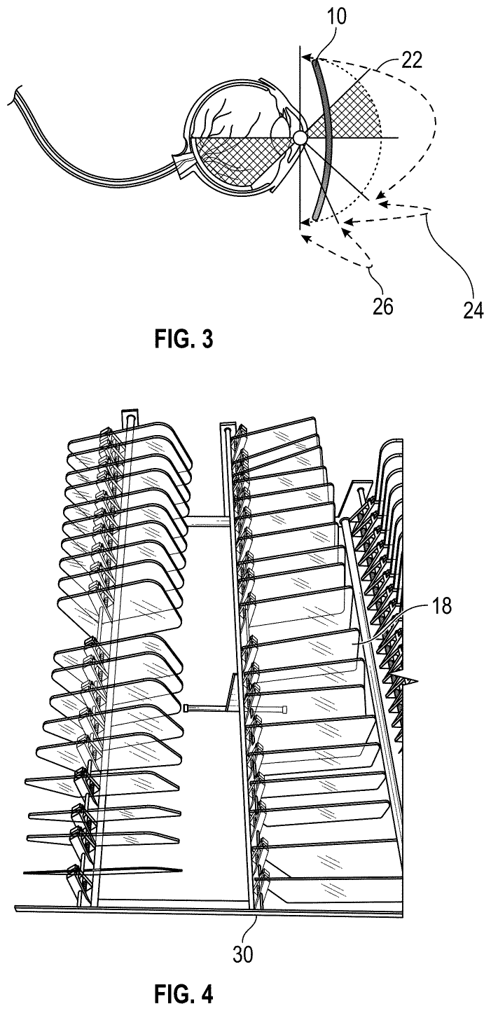

As can be seen in FIG. 3, the upper portion 12 can subtend a first ocular range 22 of 112.5°. The middle portion 14 can subtend a second ocular range 24 of 33.75°. The lower portion 16 can subtend a third ocular range 26 of 33.75°. In this way, the optical lens 10 can, when worn by a user, block almost all (99% or 98%) of the blue light and 95% of the green light coming from overhead lighting, which the human brain can interpret as sunlight. However, when looking downward, such as when watching television or reading, while the optical lens 10 still may block almost all (99%, 96%, or 93%) of the blue light, the optical lens may block less of the green light, such as 93%, 89%, or 83% by the middle portion 14 and 76% or 73% by the lower portion 16. Thus, the user can wear the glasses for two to four hours before bedtime while still being able to watch television or read a book with sufficient illumination. Nevertheless, by blocking the overhead blue and green light, the mind of the wearer may think that it is sundown or nighttime even in the environment of ambient artificial lighting.

The optical lens 10 can be comprised of polycarbonate with a gradient fill starting from the top with a red monomer.

The red upper portion of the lens blank 18 can cover 62.5% of the surface area of the lens blank or an ocular range of 112.5°. This red portion of the lens 10 can block, through absorption, between 98% and 99% of light from the 380 nm to 500 nm wavelength (blue and beginning cyan) and between 94.5% and 95.5% of 495 nm to 570 nm wavelength (the rest of the cyan and green spectrum). The purpose of having the most absorption occur in the top 62.5% of optical lens 10 can be to block blue and green light from overhead, which can be perceived by the brain in the same manner as overhead sun. As a result, disrupting circadian rhythm through artificial elongation of daytime, and more importantly the biochemical stimulation/reaction caused by blue and green light, signaling the brain to wake up or that it is still midday.

The next 18.75% of the optical lens 10 (the middle portion 14) having an ocular range of 33.75°, can be an even gradient of the red color with the orange color blocking between 96% and 99% of 380 nm to 500 nm wavelength (blue and beginning cyan part of the spectrum) and between 83% and 93% of 495 nm to 570 nm wavelength (the remainder of the cyan and green spectrum). This can allow more light to enter, allowing for a less obstructive view, and can be angled to allow optimal vision for reading, watching television, or even moving around the home without the fully obstructed view caused by the pure red tint in the upper portion 12. The bottom 18.75% of the optical lens 10 (the lower portion 16) having an ocular range of 33.75°, can be an orange tint that blocks between 93% and 99% of 380 nm to 500 nm (blue and beginning cyan portion of the spectrum) and between 73% and 76% of 495 nm to 570 nm (the left of the cyan and green spectrum). The increased perception of light in the lower portion 16 can allow for more use of peripherals, which may allow actions that would utilize more vision than a pure red lens would provide, such as operating a computer keyboard. This gradient fill can simulate a sunset-like effect, signaling to the brain the end of the day.

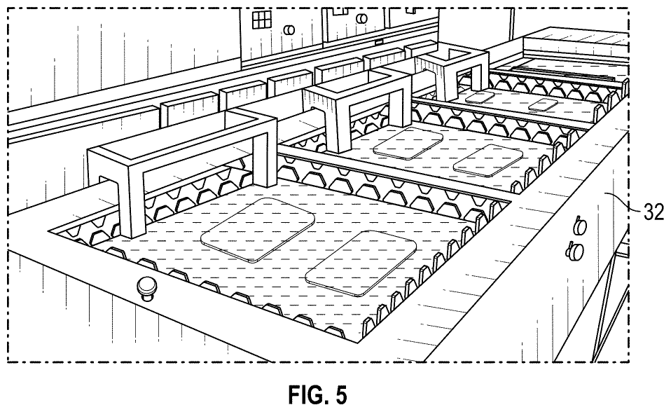

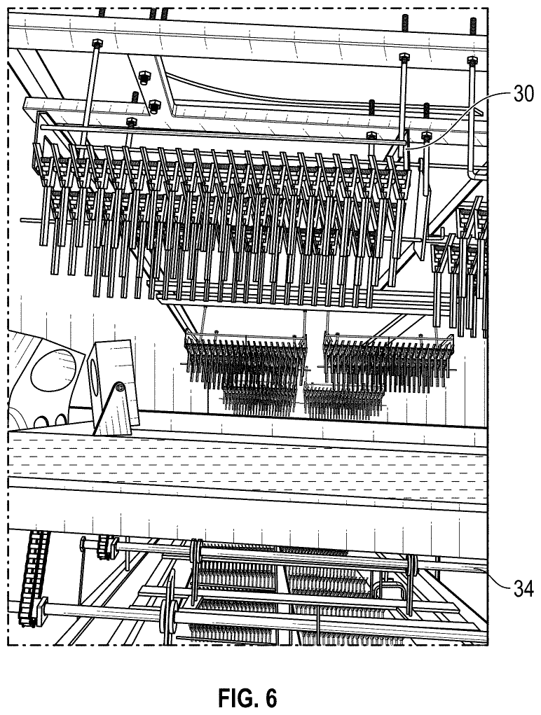

FIGS. 4 through 9 illustrate a method for tinting multiple of the lens blank 18 in a lens blank holder 30. After the multiple of the lens blank 18 have been placed into the lens blank holder 30 and prior to tinting, the multiple of lens blank 18 can be soaked for one minute in water that has a 5% sodium hydroxide (NaOH) solution in an ultrasonic cleaning tank 32 as shown in FIG. 5. As can be seen in FIG. 6, the lens blank holder 30 can be positioned in an optical lens tinting machine 34.

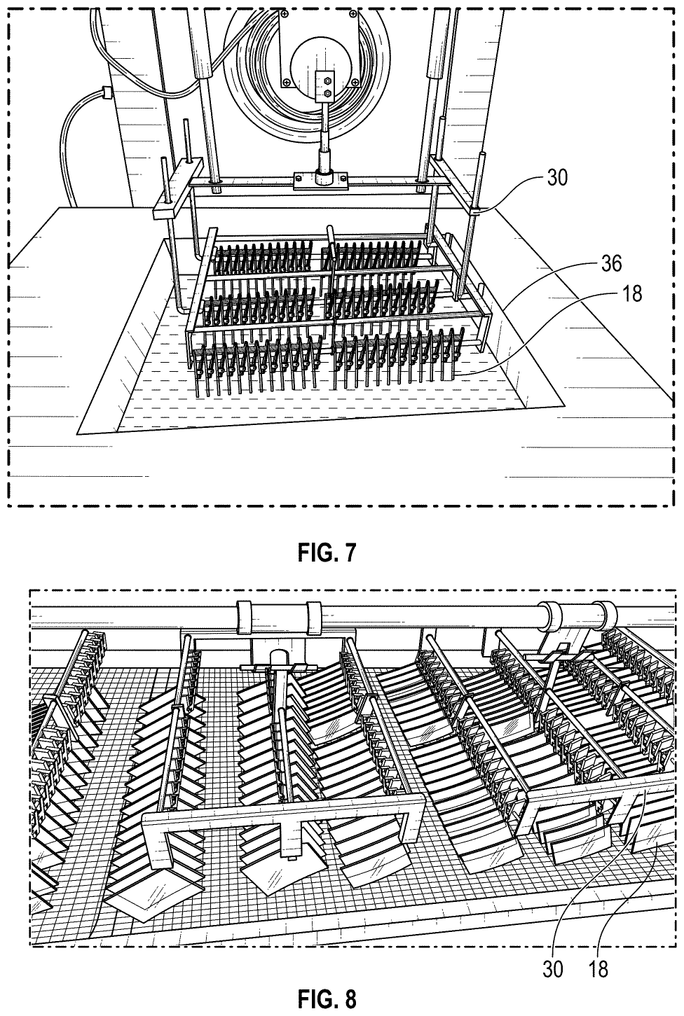

As can be seen in FIG. 7, the optical lens tinting machine 34 can include a first dye tank 36 having an orange dye (which can be a first lens tinting solution). The temperature of the orange dye can be monitored with a temperature sensor (not shown) and automatically kept at a temperature of approximately 80° C., such as with a heater. The lens blank holder 30 can be lowered so that the first 35-45 millimeters of the multiple of the lens blank 18 can be in the orange dye. The multiple of the lens blank 18 can be soaked in the orange dye for ten minutes. The lens blank holder 30 can then rise automatically with a speed of about 10 millimeters per second. This tinting procedure may last for four seconds. During this process, the bottom of the lens can have a darker color. After the orange-colored tinting is finished, the orientation of the multiple of the lens blank 18 can be reversed in the lens blank holder 30 so that untinted portions of the multiple of the lens blank 18 are facing down. Then, 35-40 millimeters of the multiple of the lens blank 18 can dipped into a second dye tank (not shown) having a red dye (which can be a second lens tinting solution), and the tinting process can be repeated.

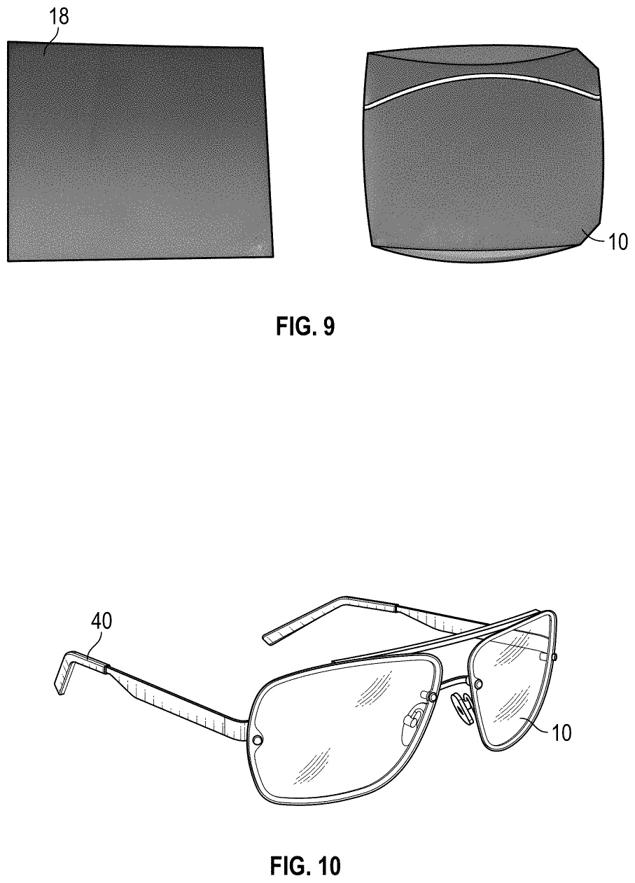

By dipping more than half of the vertical height of the lens blank 18 into the first and second dye tanks and reversing the lens blanks, a middle portion of the lens blank 18 can include both the red and the orange tint providing the lens blank 18 with three discrete zones with gradual transitions therebetween in filtering ability. The multiple of the lens blank 18 can be then cleaned and allowed to dry. As can be seen in FIG. 8, once the lens blank 18 may be clean and dry, an antireflection coating, scratch resistant coating, anti-fog coating, or oil-proof coatings may be applied. The multiple of the lens blank 18 can be then baked to a desired curvature (and potentially cut or reshaped in one or more manners) as shown in FIG. 9 to match a lens frame (and to produce the optical lens 10 shown in FIG. 2), such as for positioning in a lens frame 40 of FIG. 10. The lens frame 40 can support the optical lens 10 and be worn by an individual.

In one implementation, a circadian rhythm enhancing optical lens includes an upper portion, a middle portion, and a lower portion. The upper portion can have a first gradient fill and cover a first angular ocular range. The middle portion can be contiguous with the upper portion, have a second gradient fill, and cover a second angular ocular range different than the first ocular range. The lower portion can be contiguous with the middle portion, have a third gradient fill, and cover a third angular ocular range different than the first ocular range. The first ocular range can be greater than the second and third ocular ranges. The first ocular range can be approximately 112.5°, and the second and third ocular ranges can be each approximately 33.7°. The first gradient fill can block approximately 98% of blue visible light and 95% of green visible light. The second gradient fill can block approximately 96% of blue visible light and 89% of green visible light. The third gradient fill can block approximately 93% of blue visible light and 76% of green visible light. Transitions in gradient fill between the upper and middle, and middle and lower portions can be gradual. The lens can be manufactured from a polymer.

In another implementation, a method for manufacturing a three zone circadian rhythm enhancing optical lens blank having upper, middle, and lower sections is disclosed. The method can include: vertically positioning multiple lens blanks in a lens blank holder; ultrasonically cleaning the lens blanks; dispensing a first tinting solution into a first thermal dye tank; dispensing a second tinting solution into a second thermal dye tank; dipping a first portion of the lens blanks into the first thermal dye tank to a first depth for a first period; vertically reversing the lens blanks in the lens blank holder; and dipping a second portion of the lens blanks into the second thermal dye tank to a second depth for a second period. The first depth and the second depth can exceed one half of a vertical height of the lens blanks to create a middle section of the lens blank where placement of a first tint from the first tinting solution and a second tint from the second tinting solution overlap on the lens blanks. The first tinting solution can be red. The second tinting solution can be orange. The first depth and the second depth can be selected such that a first tint from the first tinting solution covers between 50% and 75% (such as 62.5%) of upper surface areas of the lens blanks, the first tint from the first tinting solution and a second tint from the second tinting solution covers between 10% and 30% (such as 18.75%) of middle surface areas of the lens blanks, or the second tint from the second tinting solution covers between 10% and 30% (such as 18.75%) of lower surface areas of the lens blanks.

Conditional language, such as “can,” “could,” “might,” or “may,” unless specifically stated otherwise, or otherwise understood within the context as used, is generally intended to convey that certain embodiments include, while other embodiments do not include, certain features, elements, or steps. Thus, such conditional language is not generally intended to imply that features, elements, or steps are in any way required for one or more embodiments or that one or more embodiments necessarily include logic for deciding, with or without user input or prompting, whether these features, elements, or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

Those who are skilled in the art will conceive of other variations and embodiments which fall within the scope of the present disclosure. Therefore, the invention is not to be limited by the above disclosure but is to be determined in scope by the claims which follow.

1. An apparatus comprising:
a frame configured to be worn by an individual; and
an optical lens supported by the frame, the optical lens having:
a first portion having a first tint and being configured to cover a first angular ocular range for the individual;
a second portion contiguous with the first portion, the second portion having a second tint and being configured to cover a second angular ocular range for the individual, the second tint being configured to block less of a first color of light than the first tint, the second angular ocular range being different from the first angular ocular range; and
a third portion contiguous with the second portion, the third portion having a third tint and being configured to cover a third angular ocular range for the individual, the third tint being configured to block less of the first color of light than the second tint, the third angular ocular range being different from the first angular ocular range.

2. The apparatus of claim 1, wherein the first color of light is green light.

3. The apparatus of claim 2, wherein the second tint is configured to block less of a second color of light than the first tint, and the third tint is configured to block less of the second color of light than the second tint.

4. The apparatus of claim 3, wherein the second color of light is blue light.

5. The apparatus of claim 1, wherein the first color of light is blue light.

6. The apparatus of claim 1, wherein the first angular ocular range is greater than the second angular ocular range and the third angular ocular range.

7. The apparatus of claim 1, wherein the first angular ocular range is between 100° and 125°, and the second angular ocular range and the third angular ocular range are each between 25° and 40°.

8. The apparatus of claim 7, wherein the first tint is configured to block 98% of blue light and 95% of green light.

9. The apparatus of claim 8, wherein the second tint is configured to block 96% of blue light and 89% of green light.

10. The apparatus of claim 9, wherein the third tint configured to block 93% of blue light and 76% of green light.

11. The apparatus of claim 10, wherein the first tint gradually transitions to the second tint, and the second tint gradually transitions to the third tint.

12. The apparatus of claim 1, wherein the first tint gradually transitions to the second tint, and the second tint gradually transitions to the third tint.

13. The apparatus of claim 1, wherein the optical lens comprises a polymer.

14. The apparatus of claim 1, wherein the third angular ocular range is different from the second angular ocular range.

15. The apparatus of claim 1, wherein the third angular ocular range is the same as the second angular ocular range.

16. The apparatus of claim 1, wherein the third portion is not contiguous with the first portion.

17. The apparatus of claim 1, wherein the first portion is configured to cover a first viewing area for the individual, and the second portion is configured to cover a second viewing area for the individual, the first viewing area being above the second viewing area from a perspective of the individual when wearing the frame.

18. The apparatus of claim 17, wherein the third portion is configured to cover a third viewing area for the individual, the third viewing area being below the second viewing area from the perspective of the individual when wearing the frame.
